(19) United States
(12) Patent Application Publication
(10) Pub. No.: US 2019/0250244 A1
(43) Pub. Date: Aug. 15, 2019

(54) UNDERWATER SOURCE NODE POSITIONING METHOD

(71) Applicant: SOUTH CHINA UNIVERSITY OF TECHNOLOGY, Guangzhou City (CN)

(72) Inventors: Fei JI, Guangzhou City (CN); Renzhi BAO, Guangzhou City (CN); Fangjiong CHEN, Guangzhou City (CN); Hua YU, Guangzhou City (CN)

(73) Assignee: SOUTH CHINA UNIVERSITY OF TECHNOLOGY, Guangzhou City (CN)

(21) Appl. No.: 16/269,652

(22) Filed: Feb. 7, 2019

(30) Foreign Application Priority Data
Feb. 9, 2018 (CN) 201810134114.3

(51) Int. Cl. G01S 5/06; H04B 13/02; G01S 5/02

(52) U.S. Cl. CPC G01S 5/06; G01S 5/0215; H04B 13/02

(57) ABSTRACT

Disclosed is an underwater source node positioning method, which includes the specific steps: (1) placing distributed underwater receiving nodes, the source node transmitting a pulse signal, and the receiving nodes receiving the pulse signal sent by the source node; (2) processing the signal of each receiving node; (3) according to a multipath signal received by each receiving node, performing parameter estimation of the position of the source node, specifically: (3-1) calculating a path length of each path; (3-2) calculating a delay difference between each path and a direct path; (3-3) calculating the signal received by each receiving node; (3-4) performing mesh search matching to obtain the position of the source node. Compared with the conventional method, the present invention requires fewer receiving nodes and does not require accurate clock synchronization of signals. The present invention utilizes multipath signals propagated by signals to enable more accurate positioning of the source nodes.

### CROSS-REFERENCE TO RELATED APPLICATIONS

Benefit is claimed to China Patent Application No. CN 201810134114.3, filed Feb. 9, 2018, which is incorporated by reference herein in its entirety.

### TECHNICAL FIELD

The present invention belongs to the technical field of underwater source nodes, and particularly relates to an underwater source node positioning method.

### BACKGROUND

As a key technology, underwater positioning technology has a wide range of applications in marine related scientific research, marine engineering, and military activities. With the development of science and technology, on land we can obtain position information of a target through global satellite positioning system (GPS) and radar. The signal carrier used in GPS and radar positioning is electromagnetic wave. The electromagnetic wave has good propagation characteristics in air, but the electromagnetic wave has a very high absorption loss rate when it propagates in water, so that the electromagnetic wave can only propagate a short distance in water. Therefore, under water we cannot directly use GPS and radar to locate the target. Compared with electromagnetic waves, sound waves have better propagation characteristics in water, and their attenuation in water is much smaller. The transmission attenuation of 20 KHz sound waves in water is only 2 dB/km˜3 dB/km, and the distance of propagation is farther. The excellent propagation characteristics of sound waves in water make it an important signal carrier in underwater acoustic channels. Even so, the multipath effect, Doppler shift, and signal attenuation in the underwater acoustic channel are more severe than in the terrestrial wireless channel, and the bandwidth resources available in the underwater acoustic channel are also less. These factors make the precise positioning of underwater targets very difficult. At present, there are four typical positioning algorithms time of arrival (TOA), time difference of arrival (TDOA), angle of arrival (AOA), and received signal (received signal strength indicator, RSS) method. Multipath effects exist in underwater acoustic channels. In related studies on underwater positioning problems, multipath signals are generally considered to be interference. Most underwater positioning techniques only consider direct signals to locate the target. For example, traditional TOA, TDOA, and DOA positioning methods usually only consider the direct path signal. In this case, multiple receiving nodes are needed to achieve the target positioning.

### SUMMARY

The main object of the present invention is to overcome the shortcomings and deficiencies of the prior art and to provide an underwater source node positioning method. By utilizing multipath signals, the present invention enables positioning of underwater targets using only a single receiving node.

The present invention can be implemented by the following technical solutions:

An underwater source node positioning method includes the following steps:

(1) placing distributed underwater receiving nodes, the source node transmitting a pulse signal, and the receiving nodes receiving the pulse signal sent by the source node;

(2) processing the signal of each receiving node;

(3) according to multipath signals received by each receiving node, performing parameter estimation of the position of the source node, specifically:

(3-1) calculating the path length of each path;

(3-2) calculating the delay difference between each path and the direct path;

(3-3) calculating the signal model received by each receiving node;

(3-4) constructing a matching function according to the parameters obtained in steps (3-1), (3-2), and (3-3), and using a value obtained from the matching function as an initial value of mesh search matching and performing mesh search matching, when the matching function value corresponding to the coordinates obtained by the mesh search matching is greater than the initial value, setting the matching function value of the current coordinates to a new initial value, and repeating the mesh search matching step until the maximum matching function value is obtained, the coordinates corresponding to the maximum matching function value being the position of the source node.

Further, in the step (1), the pulse signal sent by the source node is s(t), and the signal sent by the source node satisfies:

∫_{T}|s(t)|²=1

where T represents the length of signal observation time.

Further, in the step (2), the signal of each receiving node is processed to distinguish each path signal in a single node, and each path signal satisfies:

$$\{ \begin{matrix}{\int }_{T} s ( t - Δ {τ}_{k} ) {s}^{*} ( t - Δ {τ}_{{k}^{′}} ) dt \approx 0 , & k \neq {k}^{′} \\ {\int }_{T} s ( t - Δ {τ}_{k} ) {s}^{*} ( t - Δ {τ}_{{k}^{′}} ) dt \approx 1 , & k = {k}^{′}\end{matrix}$$

where s(t) represents the pulse signal sent by the source node, s*(t) represents a conjugate signal of the pulse signal transmitted by the source node, k,k′ respectively represents the k and the k′ paths, and Δτₖ represents a delay difference between the kth path and the direct path.

The multipath signals, that is, signals sent from the same transmitting end and passing through different propagation paths to the same receiving end. According to the principle of ray tracing, the multipath signal can be seen as a direct signal from the source node to the mirror of the receiving node. The position coordinates of the source node to be estimated are set as S=(xₛ, yₛ). Under the condition that the geographic information of the multipath reflection interface is known, there is a one-to-one geometric transformation relationship between the coordinates of the mirror node and the original receiving node. For the sake of convenient description, here Xₖ=(fₖ(x_{R}), gₖ(y_{R})), k=1, 2, . . . , M represents the position coordinates of the mirror of the receiving node, where (fₖ(x_{R}), gₖ(y_{R})) represents the geometric transformation relationship of the position coordinates of the mirror node and the source node. R=(x_{R}, y_{R}) represents the position coordinates of the receiving node.

Further, in the step (3-1), assuming that the position of the source node is S (xₛ,yₛ), a calculation formula of the path length of each path is as follows:

R₀=\sqrt{(xₛ−X)²+(yₛ−Y)²}

R₁=\sqrt{(xₛ−X)²+(−yₛ−Y)²}

R₂=\sqrt{(xₛ−X)²+(2*h+yₛ−Y)²}

R₃=\sqrt{(xₛ−X)²+(2*h−yₛ−Y)²}

R₄=\sqrt{(xₛ−X)²+(−2*h+yₛ−Y)²}

where X represents the abscissa of the receiving node R(x_{R}, y_{R}), Y represents the ordinate of the receiving node R(x_{R}, y_{R}), R₀ represents the length of the direct path, R₁ and R₂ respectively represents the path length after one sea surface and sea bottom refraction, R₃ and R₄ respectively represents the path length after two sea surface and sea bottom refractions, and h represents the depth from the sea floor to the sea surface.

Further, according to the calculation formula of the path length of each path in step (3-1), in the step (3-2), the calculation formula of the delay difference between the kth path and the direct path is specifically:

$$[ Δ {R}_{1} , Δ {R}_{2} , Δ {R}_{3} , Δ {R}_{4} ] = [ {R}_{1} - {R}_{0} , {R}_{2} - {R}_{0} , {R}_{3} - {R}_{0} , {R}_{4} - {R}_{0} ]$$

$$Δ {τ}_{k} = \frac{Δ {R}_{k}}{c}$$

where c is the speed of sound in the water, and ΔRₖ represents a distance difference between the kth refraction path and the direct path.

Further, in the step (3-3), a model for receiving signals at each receiving node is specifically:

$$r ( t ) = {\sum }_{k = 1}^{M} {α}_{k} s ( t - Δ {τ}_{k} ) + w ( t )$$

where r(t) represents the signal received by the receiving node, k represents the kth propagation path, M represents the total number of path signals, αₖ represents an amplitude loss coefficient of each path signal, αₖ=αₖ^{R}+jαₖ¹. Δτₖ represents a delay difference between the kth propagation path and the direct path, and w(t) represents the noise of the received signal.

Further, the total propagation loss of sound waves in the seawater is calculated as:

A(l, f)=α(f)(l−lᵣ)+p×10 log(l−lᵣ)

where A(l, f) is the total propagation loss of sound waves in the seawater, f represents the frequency of sound waves, l represents a propagation distance of the signal, lᵣ represents a reference distance, and p represents an extended loss coefficient, which is usually between 1 and 2. a(f) represents an absorption loss coefficient, and a(f) is obtained through the following experience formula:

$$a ( f ) = \frac{0.11 {f}^{2}}{1 + {f}^{2}} + \frac{44 {f}^{2}}{4100 + {f}^{2 }} + \frac{2.75 {f}^{2}}{{10}^{4}} + 0.003$$

therefore, by calculating the total propagation loss of the acoustic wave in the seawater, an amplitude loss coefficient of the signal in the received signal model at the receiving node is obtained, thereby calculating the signal received by each receiving node.

Further, in the step (3-4), according to a given initial value, a matching calculation is performed on each grid point to obtain a corresponding \hat{θ}_{ML} value, and the calculation formula is:

$$\begin{matrix}{\hat{θ}}_{ML} = arg \{ {max}_{θ} \{ log p ( r \vert θ ) \} \} \\ = arg \{ {max}_{θ} \{ - \frac{1}{{σ}_{w}^{2}} {\int }_{T} {\vert r ( t ) - {\sum }_{k = 1}^{M} {α}_{k} s ( t - Δ {τ}_{k} ) \vert}^{2} dt \} \}\end{matrix}$$

where \hat{θ}_{ML} represents the value of the matching function, r(t) represents the signal received by the receiving node, σ_{w}² is a constant and represents the variance of the noise, k represents the kth propagation path, M represents a total of M paths, αₖ represents an amplitude coefficient of each path signal, αₖ=αₖ^{R}+jαₖ^{l}, and Δτₖ represents a delay difference between the kth path and the direct path.

Further, a value obtained from the matching function is used as an initial value of mesh search matching and mesh search matching is performed, when the matching function value corresponding to the coordinates obtained by the mesh search matching is greater than the initial value, the matching function value of the current coordinates is set to a new initial value, the mesh search matching step is repeated until the maximum matching function value is obtained, and the coordinates corresponding to the maximum matching function value are the position of the source node.

Compared with the prior art, the present invention has the following advantages and beneficial effects:

1. The transmitted signal of the present invention adopts a finite-length pulse signal, which solves the problem that the receiving node cannot correctly distinguish the multipath signal under the condition that the underwater channel is complicated.

2. The present invention utilizes the multipath effect of signal propagation and has a more accurate positioning result under the condition of using the same receiving node. In the case where the receiving node is limited in the realistic situation, fewer receiving nodes are required than the conventional positioning method, which increases convenience.

3. The present invention utilizes the multipath effect of signal propagation, and solves the problem that the positioning performance is drastically reduced when the signal received at the receiving node is aliased, and the effect of improving the positioning accuracy is achieved.

### BRIEF DESCRIPTION OF THE DRAWINGS

FIG. 1 is a flow chart of this embodiment;

FIG. 2 is a schematic diagram of an underwater multipath channel model in this embodiment;

FIG. 3 is a node position distribution diagram in this embodiment; and

FIG. 4 is a diagram showing the result of the positioning simulation of this embodiment.

### DETAILED DESCRIPTION

The present invention will be further described in detail below with reference to embodiments and drawings, but the embodiments of the present invention are not limited thereto.

### Embodiment

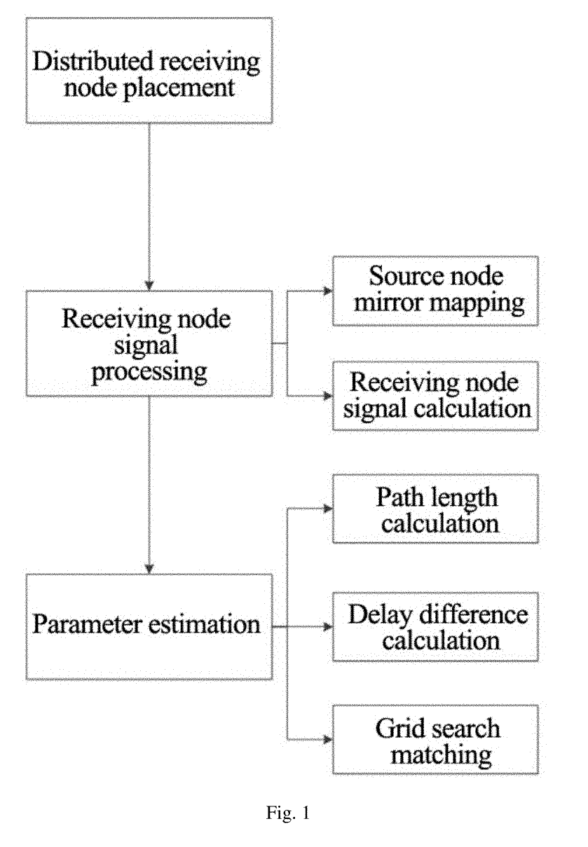

A specific flow chart of this embodiment is shown in FIG. 1. An underwater source node positioning method includes the specific steps shown in FIG. 1, including the following steps.

(1) A distributed underwater receiving node is placed, the source node transmits a pulse signal, and the receiving node receives the pulse signal sent by the source node.

In this embodiment, a distributed underwater receiving node is first placed, the source node sends a pulse signal, and the pulse signal sent by the source node satisfies

∫_{T}|s(t)|²=1

where T is the length of signal observation time.

Preferably, in this embodiment, in order to simplify the subsequent process, the following assumptions are made:

1. The speed of sound c in the water is constantly known.

2. Multipath signals are generated by reflections from the sea floor and the sea surface.

3. The noise w(t) at each receiving node is an independent and identically distributed zero-mean complex Gaussian white noise, and satisfies:

E{w(t)w*(u)}=σ_{w}²δ(t−u)

where σ_{w}² is a constant, representing the variance of the noise, and δ(t) is a unit impulse function.

(2) The signal of each receiving node is processed.

Further, each path signal of a single node can be distinguished, that is, each path signal satisfies:

$$\{ \begin{matrix}{\int }_{T} s ( t - Δ {τ}_{k} ) {s}^{*} ( t - Δ {τ}_{{k}^{′}} ) dt \approx 0 , & k \neq {k}^{′} \\ {\int }_{T} s ( t - Δ {τ}_{k} ) {s}^{*} ( t - Δ {τ}_{{k}^{′}} ) dt \approx 1 , & k = {k}^{′}\end{matrix}$$

where s(t) represents the pulse signal sent by the source node, and s*(t) represents a conjugate signal of the pulse signal transmitted by the source node, k,k′ respectively represents the k and the k′ paths, and Δτₖ represents a delay difference between the kth path and the direct path.

(3) According to the multipath signal received by each receiving node, parameter estimation of the position of the source node is performed, specifically:

According to the principle of ray tracing, the multipath signal can be seen as a direct signal from the source node to the mirror of the receiving node. The position coordinates of the source node to be estimated are set as S=(xₛ, yₛ). Under the condition that the geographic information of the multipath reflection interface is known, there is a one-to-one geometric transformation relationship between the coordinates of the mirror node and the original receiving node. For the sake of convenient description, here Xₖ=(fₖ(x_{R}), gₖ(y_{R})), k=1, 2, . . . , M represents the position coordinates of the mirror of the receiving node, where (fₖ(x_{R}), gₖ(y_{R})) represents the geometric transformation relationship of the position coordinates of the mirror node and the source node. R=(x_{R}, y_{R}) represents the position coordinates of the receiving node.

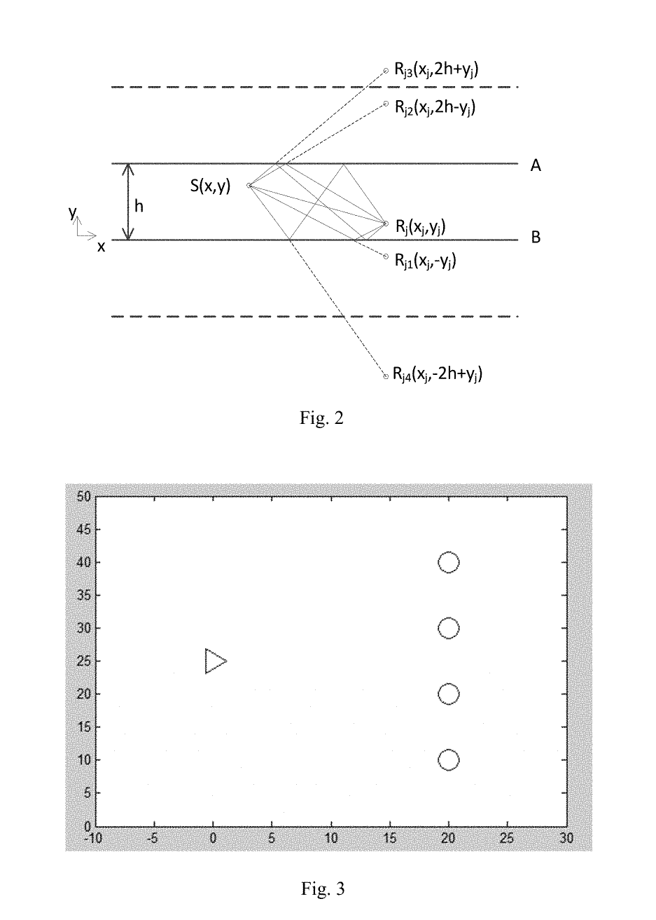

FIG. 2 is a schematic diagram of an underwater multipath channel model in this embodiment. Set the coordinates of the source node as S(x,y), and the coordinates of the receiving node as Rⱼ=(xⱼ, −yⱼ). The coordinates of a mirror node 1 that has been flipped over the sea surface are Rⱼ₁=(xⱼ, −yⱼ), the coordinates of a mirror node 2 that has been flipped over the sea surface are Rⱼ₂=(xⱼ, 2h−yⱼ), the coordinates a the mirror node 3 that has been flipped twice by the sea surface are Rⱼ₃=(xⱼ, 2h+yⱼ), and the coordinates of a mirror node 4 that has been flipped twice by the sea surface are Rⱼ₄=(xⱼ, −2h+yⱼ), where h is the depth from the sea floor to the sea surface.

According to the above ray tracing principle, the obtained position distribution of the source node and each receiving node is as shown in FIG. 3, where the triangle is a transmitting node and the circle is a receiving node.

(3-1) A path length of each path is calculated.

Assuming the position of the source node is S(xₛ, yₛ), the length of each path is expressed as:

R₀=\sqrt{(xₛ−X)²+(yₛ−Y)²}

R₁=\sqrt{(xₛ−X)²+(−yₛ−Y)²}

R₂=\sqrt{(xₛ−X)²+(2*h+yₛ−Y)²}

R₃=\sqrt{(xₛ−X)²+(2*h−yₛ−Y)²}

R₄=\sqrt{(xₛ−X)²+(−2*h+yₛ−Y)²}

where X represents the abscissa of the receiving node R(x_{R}, y_{R}), Y represents the ordinate of the receiving node R(x_{R}, y_{R}), R₀ represents the length of the direct path, R₁ and R₂ respectively represents the path length after one sea surface and sea bottom refraction, R₃ and R₄ respectively represents the path length after two sea surface and sea bottom refractions, and h represents the depth from the sea floor to the sea surface.

(3-2) A delay difference between each path and the direct path is calculated.

In this embodiment, the sound velocity c in the water is constantly known, and therefore, when the sound velocity c in the underwater acoustic channel is a constant value, the delay difference is calculated as follows:

$$[ Δ {R}_{1} , Δ {R}_{2} , Δ {R}_{3} , Δ {R}_{4} ] = [ {R}_{1} - {R}_{0} , {R}_{2} - {R}_{0} , {R}_{3} - {R}_{0} , {R}_{4} - {R}_{0} ]$$

$$Δ {τ}_{k} = \frac{Δ {R}_{k}}{c}$$

where ΔRₖ represents a distance difference between the kth refraction path and the direct path.

(3-3) The signal received by each receiving node is calculated.

The total propagation loss of sound waves in the seawater is calculated as follows:

A(l, f)=α(f)(l−lᵣ)+p×10 log(l−lᵣ)

where A(l, f) is the total propagation loss of sound waves in the seawater, f represents the frequency of sound waves, l represents a propagation distance of the signal, and lᵣ represents a reference distance. p represents an extended loss coefficient, which is usually between 1 and 2. a(f) represents an absorption loss coefficient, and a(f) is obtained through the following experience formula:

$$a ( f ) = \frac{0.11 {f}^{2}}{1 + {f}^{2}} + \frac{44 {f}^{2}}{4100 + {f}^{2}} + \frac{2.75 {f}^{2}}{{10}^{4}} + 0.003$$

Further, the model of the received signal at each receiving node is expressed as:

$$r ( t ) = {\sum }_{k = 1}^{M} {α}_{k} s ( t - Δ {τ}_{k} ) + w ( t )$$

where r(t) represents the signal received by the receiving node, k represents the kth propagation path, M represents the total number of path signals, and αₖ represents an amplitude loss coefficient of each path signal, αₖ=αₖ^{R}+jαₖ^{l}. Δτₖ represents a delay difference between the kth propagation path and the direct path, and w(t) represents the noise of the received signal.

Therefore, according to the total propagation loss of the acoustic wave in the seawater, an amplitude loss coefficient of the signal in the received signal model at each receiving node is obtained, thereby calculating the signal received by each receiving node.

(3-4) Grid search matching is performed to obtain the position of the source node.

Given the constraints of the coordinates, that is, an initial value of the matching function is given. For each given coordinate, a corresponding \hat{θ}_{ML} value can be calculated.

The formula is as follows:

$$\begin{matrix}{\hat{θ}}_{ML} = arg \{ {max}_{θ} \{ log p ( r \vert θ ) \} \} \\ = arg \{ {max}_{θ} \{ - \frac{1}{{σ}_{w }^{2}} {\int }_{T} {\vert r ( t ) - {\sum }_{k = 1}^{M} {α}_{k} s ( t - Δ {τ}_{k} ) \vert}^{2} dt \} \}\end{matrix}$$

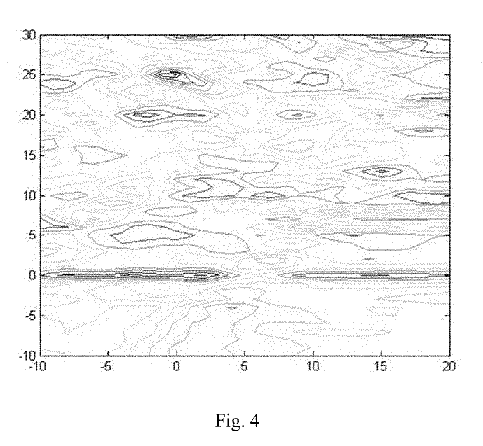

A value obtained from the matching function is used as an initial value of mesh search matching and mesh search matching is performed, when the matching function value corresponding to the coordinates obtained by the mesh search matching is greater than the initial value, the matching function value of the current coordinates is set to a new initial value, and the mesh search matching step is repeated until the maximum matching function value is obtained, the coordinates corresponding to the maximum matching function value are the position of the source node. In this embodiment, the positioning simulation result obtained by the present invention is shown in FIG. 4. As can be seen from the figure, the positioning method of the present invention can accurately locate the position of the source node and have a more accurate positioning effect.

The above-described embodiments are preferred embodiments of the present invention, but the embodiments of the present invention are not limited to the above-described embodiments, and any other changes, modifications, substitutions, combinations, and simplifications thereof made without departing from the spirit and scope of the present invention should all be equivalent replacements and are included in the scope of the present invention.

We claim:

1. An underwater source node positioning method, comprising:
(1) placing distributed underwater receiving nodes, the source node transmitting a pulse signal, and the receiving nodes receiving the pulse signal sent by the source node;
(2) processing the signal of each receiving node;
(3) according to a multipath signal received by each receiving node, performing parameter estimation of the position of the source node, specifically:
(3-1) calculating a path length of each path;
(3-2) calculating a delay difference between each path and a direct path;
(3-3) calculating the signal received by each receiving node;
(3-4) constructing a matching function according to the parameters obtained in steps (3-1), (3-2), and (3-3), and using a value obtained from the matching function as an initial value of mesh search matching and performing mesh search matching, when the matching function value corresponding to the coordinates obtained by the mesh search matching is greater than the initial value, setting the matching function value of the current coordinates to a new initial value, and repeating the mesh search matching step until the maximum matching function value is obtained, the coordinates corresponding to the maximum matching function value being the position of the source node.

2. The underwater source node positioning method according to claim 1, wherein the pulse signal sent by the source node in the step (1) satisfies the following requirements:
∫_{T}|s(t)|²=1
where s(t) represents the pulse signal sent by the source node, and T represents the length of signal observation time.

3. The underwater source node positioning method according to claim 1, wherein in the step (2), each path signal in a single receiving node is distinguished, and each path signal satisfies the following requirements: :
$$\{ \begin{matrix}{\int }_{T} s ( t - Δ {τ}_{k} ) {s}^{*} ( t - Δ {τ}_{{k}^{′}} ) dt \approx 0 , & k \neq {k}^{′} \\ {\int }_{T} s ( t - Δ {τ}_{k} ) {s}^{*} ( t - Δ {τ}_{{k}^{′}} ) dt \approx 1 , & k = {k}^{′}\end{matrix}$$
where s(t) represents the pulse signal sent by the source node, and s*(t) represents a conjugate signal of the pulse signal transmitted by the source node, k,k′ respectively represents the k and the k paths, and Δτₖ represents a delay difference between the kth path and the direct path.

4. The underwater source node positioning method according to claim 1, wherein a calculation formula of the path length of each path in the step (3-1) is specifically:
R₀=\sqrt{(xₛ−X)²+(yₛ−Y)²}
R₁=\sqrt{(xₛ−X)²+(−yₛ−Y)²}
R₂=\sqrt{(xₛ−X)²+(2*h+yₛ−Y)²}
R₃=\sqrt{(xₛ−X)²+(2*h−yₛ−Y)²}
R₄=\sqrt{(xₛ−X)²+(−2*h+yₛ−Y)²}
where the position coordinates of the source node to be estimated are (xₛ, yₛ): X represents the abscissa of the receiving node R(x_{R}, y_{R}), Y represents the ordinate of the receiving node R(x_{R}, y_{R}), R₀ represents the length of the direct path, R₁ and R₂ respectively represents the path length after one sea surface and sea bottom refraction, R₃ and R₄ respectively represents the path length after two sea surface and sea bottom refractions, and h represents the depth from the sea floor to the sea surface.

5. The underwater source node positioning method according to claim 4, wherein a calculation formula of the delay difference between the kth path and the direct path according to the path length of each path is specifically:
$$[ Δ {R}_{1} , Δ {R}_{2} , Δ {R}_{3} , Δ {R}_{4} ] = [ {R}_{1} - {R}_{0} , {R}_{2} - {R}_{0} , {R}_{3} - {R}_{0} , {R}_{4} - {R}_{0} ]$$
$$Δ {τ}_{k} = \frac{Δ {R}_{k}}{c}$$
where c is the speed of sound in the water, ΔRₖ represents a distance difference between the kth refraction path and the direct path, and Δτₖ represents a delay difference between the kth path and the direct path.

6. The underwater source node positioning method according to claim 1, wherein in the step (3-3), a model for receiving signals at each receiving node is first established, specifically:
$$r ( t ) = {\sum }_{k = 1}^{M} {α}_{k} s ( t - Δ {τ}_{k} ) + w ( t )$$
where r(t) represents the signal received by the receiving node, k represents the kth propagation path, M represents the total number of path signals, αₖ represents an amplitude loss coefficient of each path signal, αₖ=αₖ^{R}+jαₖ^{l}; Δτₖ represents a delay difference between the kth propagation path and the direct path, and w(t) represents the noise of the received signal.

7. The underwater source node positioning method according to claim 1, wherein in the step (3-3), the total propagation loss of the acoustic wave in the seawater is calculated, and the specific calculation formula is:
A(l, f)=α(f)(l−lᵣ)+p×10 log(l−lᵣ)
where A(l, f) is the total propagation loss of sound waves in the seawater, f represents the frequency of sound waves, l represents a propagation distance of the signal, lᵣ represents a reference distance; p represents an extended loss coefficient, which is usually between 1 and 2; a(f) represents an absorption loss coefficient, and a(f) is obtained through the following experience formula:
$$a ( f ) = \frac{0.11 {f}^{2}}{1 + {f}^{2 }} + \frac{44 {f}^{2}}{4100 + {f}^{2}} + \frac{2.75 {f}^{2}}{{10}^{4}} + 0.003$$
therefore, by calculating the total propagation loss of the acoustic wave in the seawater, an amplitude loss coefficient of the signal in the received signal model at the receiving node is obtained, thereby calculating the signal received by each receiving node.

8. The underwater source node positioning method according to claim 1, wherein in the step (3-4), a matching function is constructed, and expressed as:
$$\begin{matrix}{\hat{θ}}_{ML} = arg \{ {max}_{θ} \{ log p ( r \vert θ ) \} \} \\ = arg \{ {max}_{θ} \{ - \frac{1}{{σ}_{w }^{2}} {\int }_{T} {\vert r ( t ) - {\sum }_{k = 1}^{M} {α}_{k} s ( t - Δ {τ}_{k} ) \vert}^{2} dt \} \}\end{matrix}$$
where \hat{θ}_{ML} represents the value of the matching function, r(t) represents the signal received by the receiving node, σ_{w}² is a constant and represents the variance of the noise, k represents the kth propagation path, M represents a total of M paths, αₖ represents an amplitude coefficient of each path signal, αₖ=αₖ^{R}+jαₖ^{l}, and Δτₖ represents a delay difference between the kth path and the direct path.
